(19) United States
(12) Patent Application Publication
(10) Pub. No.: US 2025/0363888 A1
(43) Pub. Date: Nov. 27, 2025

(54) VEHICLE-MOUNTED APPARATUS, VEHICLE-MOUNTED SYSTEM, SERVER COMPUTER, CONTROL METHOD, AND COMPUTER PROGRAM

(71) Applicants: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(72) Inventor: Akihiro OGAWA, Osaka-shi (JP)

(73) Assignees: SUMITOMO ELECTRIC INDUSTRIES, LTD., Osaka-shi, Osaka (JP); AUTONETWORKS TECHNOLOGIES, LTD., Yokkaichi-shi, Mie (JP); SUMITOMO WIRING SYSTEMS, LTD., Yokkaichi-shi, Mie (JP)

(21) Appl. No.: 18/873,982

(22) PCT Filed: May 23, 2023
(86) PCT No.: PCT/JP2023/019048

§ 371 Date: Dec. 11, 2024

(30) Foreign Application Priority Data
Jun. 17, 2022 (JP) 2022-097693

(51) Int. Cl. G08C 13/00; G08C 15/06

(52) U.S. Cl. CPC G08C 13/00; G08C 15/06

(57) ABSTRACT

A vehicle-mounted apparatus that includes a processor configured to: determine a real-time requirement relating to received data that has been received from outside the vehicle; calculate an elapsed period that is a time from generation of original data for the received data until the received data is received by the vehicle-mounted apparatus; calculate an estimation period from reception of the received data until usage of the received data commences; and determine whether the received data is usable based on the real-time requirement, the elapsed period, and the estimation period, wherein: the real-time requirement indicates a tolerated delay from generation of the original data to the usage of the received data, the received data has been appended with time information for specifying a time when the original data was generated, and the processor calculates the elapsed period based on a reception time of the received data and the time information.

### BACKGROUND

The present disclosure relates to a vehicle-mounted apparatus, a vehicle-mounted system, a server computer, a control method, and a computer program. This application is based upon and claims the benefit of priority of the prior Japanese Patent Application No 2022-097693, filed on 17 Jun. 2022, the entire contents of which are incorporated herein by reference.

Low-latency communication environments, such as 4G (Fourth Generation Mobile Communication System) and 5G (Fifth Generation Mobile Communication System) are becoming widespread. The installation of various electronic devices in automobiles, on motorcycles, and the like (hereinafter referred to as “vehicles”) is also progressing. Together with this, a system has been proposed where a vehicle-mounted apparatus installed in a vehicle and a server computer cooperate to assist in the driving of the vehicle (hereinafter referred to as “cooperative driving”). Cooperative driving uses real-time information (for example, dynamic information about dynamic objects detected by sensors) in addition to conventional non-real-time information (for example, statistical information such as congestion information). Since various types of data with different real-time needs are utilized, it is important to process data appropriately in keeping with its real-time needs.

JP 2014-165675A indicated below discloses a transfer system capable of favorably transferring real-time data. This transfer system includes a transfer server. The transfer server includes a non real-time data filtering unit. The non-real-time data filtering unit filters out (that is, deletes) non-real-time data included in received data. In more detail, the date and time information (that is, a creation date and time) of a message contained in the received data is compared with the system date and time of the transfer server, and if there is a time difference that exceeds a predetermined threshold, the message is deleted without being transferred.

### SUMMARY

A vehicle-mounted apparatus according to an aspect of the present disclosure is a vehicle mounted apparatus that includes a processor configured to: determine a real-time requirement relating to received data that has been received from outside the vehicle; calculate an elapsed period that is a time from generation of original data for the received data until the received data is received by the vehicle mounted apparatus; calculate an estimation period from reception of the received data until usage of the received data commences; and determine whether the received data is usable based on the real-time requirement, the elapsed period, and the estimation period, wherein: the real-time requirement indicates a tolerated delay from generation of the original data to the usage of the received data, the received data has been appended with time information for specifying a time when the original data was generated, and the processor calculates the elapsed period based on a reception time of the received data and the time information.

### BRIEF DESCRIPTION OF THE DRAWINGS

FIG. 1 is a schematic diagram depicting an example usage of a vehicle-mounted system according to an embodiment of the present disclosure.

FIG. 2 is a block diagram depicting the hardware configuration of the vehicle-mounted system depicted in FIG. 1.

FIG. 3 is a block diagram depicting the hardware configuration of a vehicle-mounted gateway depicted in FIG. 2.

FIG. 4 is a block diagram depicting the hardware configuration of a server depicted in FIG. 1.

FIG. 5 is a block diagram depicting the software configuration of a vehicle-mounted system and a server.

FIG. 6 is a diagram depicting the timing of processing from generation of original data to usage at a vehicle as driving assistance information.

FIG. 7 is a flowchart depicting the processing executed by the server.

FIG. 8 is a block diagram depicting the functional configuration of a vehicle-mounted gateway.

FIG. 9 is a flowchart depicting the processing executed by a vehicle-mounted gateway.

FIG. 10 is a block diagram depicting the functional configuration of a server according to a modification.

FIG. 11 is a schematic diagram depicting provision of information by the server depicted in FIG. 10.

### DETAILED DESCRIPTION OF EMBODIMENTS

### Technical Problem

The transfer system disclosed in JP 2014-165675A ensures that data being transferred is real-time by deleting non-real-time data. However, ensuring that data is real-time results in an increase in the amount of data that is wasted. In a situation where communication involves a mixture of data with different real-time needs, the technology described in JP 2014-165675A will be unable to make effective use of the data transferred for cooperative driving without wasting data.

It is therefore an object of the present disclosure to provide a vehicle-mounted apparatus, a vehicle-mounted system, a server computer, a control method, and a computer program that can make effective use of data in a situation where data communication involves a mixture of data with different real-time needs.

### Advantageous Effects of Disclosure

According to the present disclosure, it is possible to provide a vehicle-mounted apparatus, a vehicle-mounted system, a server computer, a control method, and a computer program that can make effective use of data in a situation where data communication involves a mixture of data with different real-time needs.

### Outline of Embodiments of the Present Disclosure

Several embodiments of the present disclosure will be listed and described in outline. The embodiments described below may also be freely combined, at least in part.
(1) A vehicle-mounted apparatus according to an aspect of the present disclosure is a vehicle-mounted apparatus mounted in a vehicle and includes: a real-time requirement determination unit for determining a real-time requirement relating to received data that has been received from outside the vehicle; an elapsed period calculation unit for calculating an elapsed period that is a time from generation of original data for the received data until the received data is received by the vehicle mounted apparatus; an estimation period calculation unit for calculating an estimation period from reception of the received data until usage of the received data commences; and a usability determination unit for determining whether the received data is usable based on the real-time requirement, the elapsed period, and the estimation period, wherein the real-time requirement indicates a tolerated delay from generation of the original data to the usage of the received data, the received data has been appended with time information for specifying a time when the original data was generated, and the elapsed period calculation unit calculates the elapsed period based on a reception time of the received data and the time information. By doing so, the vehicle-mounted apparatus can make effective use of received data (as one example, driving assistance information).
(2) In the vehicle-mounted apparatus according to (1) above, the usability determination unit can determine that the received data is unusable if a total of the elapsed period and the estimation period does not satisfy the real-time requirement, the vehicle-mounted apparatus can further include a data conversion unit for converting, on receiving a determination by the usability determination unit that the received data is unusable, the received data into low requirement data with a lower real-time requirement than the real-time requirement of the received data, and, when the data conversion unit is not capable of generating the low-requirement data, the received data may be discarded. By doing so, it is possible for a vehicle-mounted apparatus to make effective use of the received data (as one example, driving assistance information). Also, since data that cannot be effectively used is discarded, it is possible to suppress the wasteful storage of data that is unused.
(3) In the vehicle-mounted apparatus according to (1) or (2) above, the received data may be appended with service specifying information for specifying a service where the received data is to be used, and the real time requirement determination unit may determine the real-time requirement based on the service specifying information. By doing so, it is possible to easily determine the real-time requirement.
(4) In the vehicle-mounted apparatus according to (1) or (2) above, the real-time requirement determination unit may determine the real-time requirement based on at least one of a type of the received data and a service where the received data is to be used. By doing so, it is possible to accurately determine the real-time requirement.
(5) In the vehicle-mounted apparatus according to (4) above, the type may
include dynamic information, predictive information, and statistical information, and the service may include driving assistance including control of a driving speed of the vehicle, drive planning including control of a lane in which the vehicle is running, and route selection for controlling the planned driving route of the vehicle. By doing so, it is possible to safely and accurately control the running of the vehicle.
(6) In the vehicle mounted apparatus according to any one of (1) to (5) above, the received data may be used by an electronic control unit mounted in the vehicle, the estimation period calculation unit may calculate the estimation period by adding a transfer delay, which is a time required to transfer the received data to the electronic control unit, a standby period, which is a time required for the vehicle to reach a position where the received data is to be used, and a predetermined time, and the predetermined time may represent a total of a processing time of the real-time requirement determination unit, a processing time of the elapsed period calculation unit, and a processing time of the usability determination unit. By doing so, it is possible to use the received data (which for example is driving assistance information) much more effectively.
(7) A vehicle-mounted system according to a second aspect of the present disclosure is a vehicle-mounted system mounted in a vehicle, including: the vehicle-mounted apparatus according to any one of (1) to (6) above; a communication unit for receiving the received data; and an electronic control unit to which the received data that has been determined by the vehicle-mounted apparatus to be usable is transferred. By doing so, it is possible for the vehicle-mounted system to make effective use of the received data (which for example is driving assistance information).
(8) A server computer according to a third aspect of the present disclosure is a server computer including: a communication unit for receiving sensor data from outside; an analysis unit for analyzing the sensor data and generating first driving assistance information; and a vehicle specifying unit for specifying a first vehicle capable of reaching a generation location of the sensor data within a first tolerated delay corresponding to a first real-time requirement corresponding to the first driving assistance information, wherein the communication unit also transmits the first driving assistance information to a vehicle mounted apparatus of the first vehicle. By doing so, it is possible for the server computer to transmit driving assistance information only to vehicles that are capable of effectively using the driving assistance information, which prevents wasteful transmission to vehicles incapable of using the information. At a vehicle, the received data (driving assistance information) can be quickly transferred to the applied service (for example, an end ECU (Electronic Control Unit)) without having to determine whether the received data can be effectively used.
(9) The server computer according to (8) may further include a data conversion unit for generating, from the first driving assistance information, second driving assistance information corresponding to a second real-time requirement obtained by lowering the first real-time requirement, the vehicle specifying unit may also specify a second vehicle capable of reaching the generation location within a second tolerated delay corresponding to the second real-time requirement, and the communication unit may also transmit the second driving assistance information to a vehicle-mounted apparatus of the second vehicle. By doing so, it is possible for a larger number of vehicles to make effective use of the driving assistance information.
(10) A control method according to a fourth aspect of the present disclosure is a control method of a vehicle-mounted system including a vehicle-mounted apparatus mounted in a vehicle, the control method including: a real-time requirement determination step of the vehicle mounted apparatus determining a real-time requirement relating to received data that has been received from outside the vehicle; an elapsed period calculation step of the vehicle-mounted apparatus calculating an elapsed period that is a time from generation of original data for the received data until the received data is received by the vehicle-mounted apparatus; an estimation period calculation step of the vehicle-mounted apparatus calculating an estimation period from reception of the received data until usage of the received data commences; and a usability determination step of the vehicle-mounted apparatus determining whether the received data is usable based on the real-time requirement, the elapsed period, and the estimation period, wherein the real-time requirement indicates a tolerated delay from generation of the original data to the usage of the received data, the received data has been appended with time information for specifying a time when the original data was generated, and the elapsed period calculation step includes a step of the vehicle mounted apparatus calculating the elapsed period based on a reception time of the received data and the time information. By doing so, the vehicle-mounted apparatus can make effective use of the received data (which for example is driving assistance information).
(11) A computer program according to a fifth aspect of the present disclosure is a computer program causing a computer mounted in a vehicle to implement: a real-time requirement determination function for determining a real-time requirement relating to received data that has been received from outside the vehicle; an elapsed period calculation function for calculating an elapsed period that is a time from generation of original data for the received data until reception of the received data; an estimation period calculation function for calculating an estimation period from reception of the received data until usage of the received data commences; and a usability determination function for determining whether the received data is usable based on the real-time requirement, the elapsed period, and the estimation period, wherein the real-time requirement indicates a tolerated delay from generation of the original data to the usage of the received data, the received data has been appended with time information for specifying a time when the original data was generated, and the elapsed period calculation function includes a function of calculating the elapsed period based on a reception time of the received data and the time information. By doing so, the vehicle mounted apparatus can make effective use of the received data (which for example is driving assistance information).

### Detailed Description of Embodiments of the Present Disclosure

In the embodiments described below, components that are the same have been assigned the same reference numerals. The names and functions of such components are also the same. Accordingly, detailed description of such components will not be repeated.

### Overall Configuration

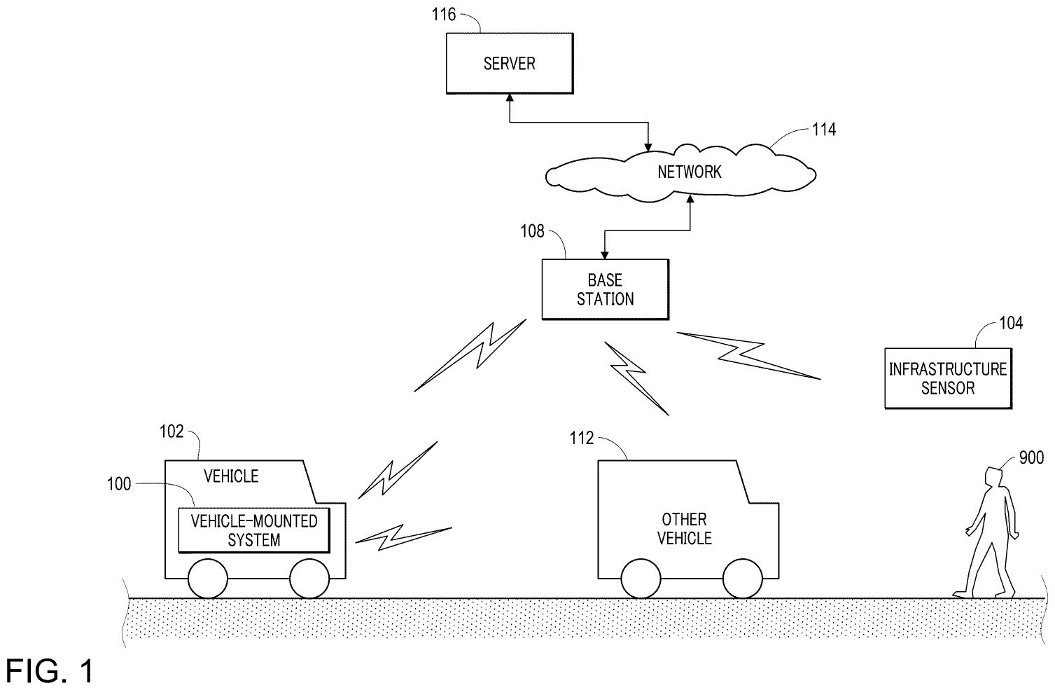

As depicted in FIG. 1, a vehicle-mounted system 100 according to an embodiment of the present disclosure is installed in a vehicle 102. The vehicle-mounted system 100 receives data for cooperative driving (that is, “driving assist information”) from a server 116, which is a server computer. The data transmitted from the server 116 is a mixture of data with different real-time needs. Communication between the vehicle-mounted system 100 and the server 116 is performed via a base station 108.

As examples, the base station 108 provides a mobile communication service via 4G lines, 5G lines, or the like. The base station 108 is connected to a network 114. The vehicle-mounted system 100 installed in the vehicle 102 has a communication function that complies with a communication specification (such as 4G communication and 5G communication) handled by the base station 108. Note that the communication between the vehicle-mounted system 100 and the server 116 may be direct communication that does not pass the base station 108.

An infrastructure sensor 104 is an apparatus that is permanently installed on a road (including at an intersection) or in the periphery of a road (hereinafter also referred to as “at the roadside”) and has a function of acquiring information at the roadside. As examples, the infrastructure sensor 104 is an image sensor (such as a digital monitoring camera), a radar (such as a millimeter wave radar), or a laser sensor (such as LiDAR (Light Detection and Ranging)). The infrastructure sensor 104 has a communication function of communicating with the base station 108 and transmits acquired sensor data to the server 116 via the base station 108 and the network 114.

A pedestrian 900, the vehicle 102, and another vehicle 112 depicted in FIG. 1 are detected by the infrastructure sensor 104. The vehicle 102 is also equipped with a sensor as described below. The other vehicle 112 is equipped with a vehicle-mounted system and a sensor in the same way as the vehicle 102. The pedestrian 900 is also subjected to detection by the sensors provided in the vehicle 102 and the other vehicle 112.

The sensor data acquired by the sensors mounted on the vehicle 102 and the other vehicle 112 is transmitted to server 116 via the base station 108 and the network 114. The server 116 analyzes the sensor data received from the infrastructure sensor 104, the vehicle 102, and the other vehicle 112, and stores an analysis result as dynamic information. The server 116 transmits this dynamic information to a vehicle-mounted apparatus installed in a vehicle as driving assistance information.

The dynamic information is information relating to a dynamic object that has been detected by the sensors (that is, the infrastructure sensors and the vehicle-mounted sensors). The concept of “dynamic objects” is not limited to moving objects (such as people or vehicles) and also includes objects that have a movement function but are stationary. Dynamic information may include information about the dynamic objects themselves (hereinafter referred to as “attributes”) and information relating to displacement of the dynamic objects (such as their positions, moving speed, moving direction and time, and the like). The dynamic information is used as driving assistance information for autonomous driving of a vehicle, and is also used to determine a recommended route, which will be described later.

The attributes include at least attributes that are simple (hereinafter referred to as “simple attributes”). However, the attributes may also include more detailed attributes (hereinafter referred to as “detailed attributes”). The simple attributes are used to roughly classify dynamic objects, and as examples include “person”, “bicycle”, “motorcycle”, and “automobile”. The detailed attributes are used to classify dynamic objects more precisely, and include states of the dynamic objects. As one example, if the simple attribute is “person”, the detailed attributes may include “child”, “adult”, “elderly person”, or the like, and may further include states like “walking while using a smartphone” and “has ignored a traffic light”. As another example, if the simple attribute is “automobile”, examples of the detailed attributes may include “regular car” and “large vehicle”, and may further include “bus”, “taxi”, “emergency vehicle (ambulance or fire engine)”, and “distracted driver”. Note that the simple attributes and the detailed attributes are not limited to these examples, and may include any freely chosen attributes. Out of the information relating to displacement of a dynamic object, the time information may for example be the generation times of position information, moving speed information, and moving direction information.

FIG. 1 depicts one base station 108, one infrastructure sensor 104, and two vehicles, that is, the vehicle 102 and the other vehicle 112, equipped with vehicle-mounted systems. However, this is merely one example. In a typical situation, a plurality of base stations are provided and a plurality of vehicles are equipped with vehicle-mounted systems. Vehicles that are not equipped with vehicle mounted systems may also be present. Such vehicles that are not equipped with vehicle-mounted systems are detected as dynamic objects.

### Hardware Configuration of Vehicle-Mounted System

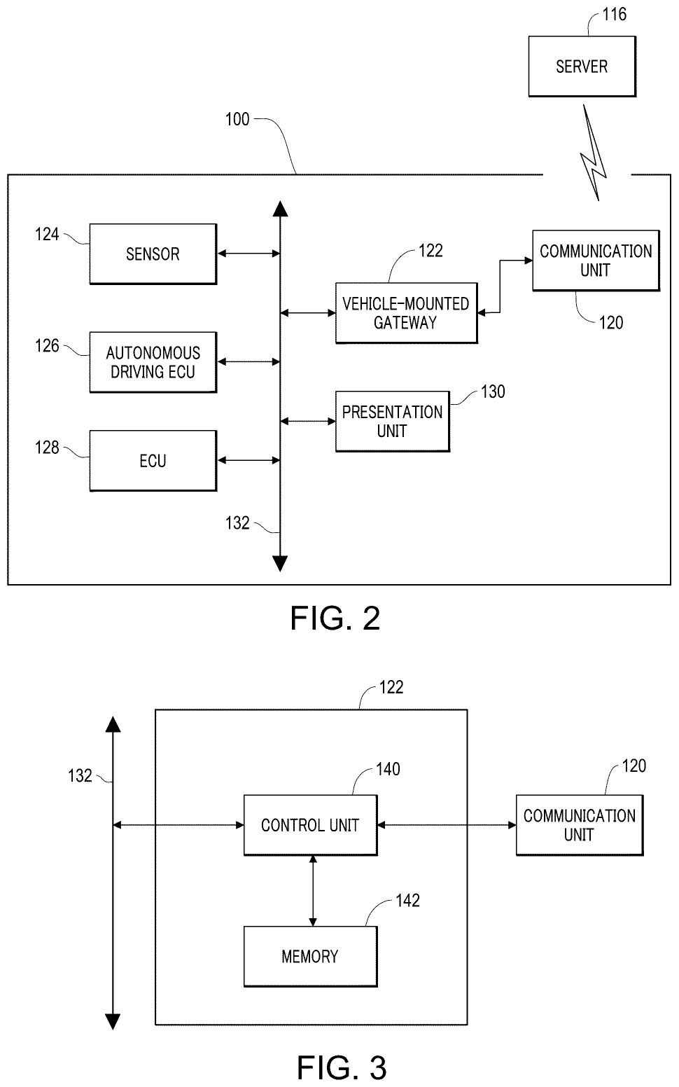

FIG. 2 depicts one example of the hardware configuration of the vehicle-mounted system 100 installed in the vehicle 102. The vehicle-mounted system 100 includes a communication unit 120 (communicator), a vehicle mounted gateway 122, a sensor 124, an autonomous driving ECU 126, an ECU 128, a presentation unit 130, and a bus 132. Note that the vehicle-mounted system 100 includes a plurality of ECUs aside from the autonomous driving ECU 126, with FIG. 2 depicting the ECU 128 as a representative of such ECUs.

The communication unit 120 performs wireless communication with apparatuses outside the vehicle 102 (as one example, communication with an infrastructure sensor 104 or the like via a base station 108). The communication unit 120 includes an integrated circuit (IC) that performs modulation and multiplexing as used in wireless communication, an antenna for transmitting and receiving radio waves of a predetermined frequency, an RF (Radio Frequency) circuit, and the like. The communication unit 120 also includes a communication function for communicating with a global navigation satellite system (GNSS), such as Global Positioning System (GPS). The communication unit 120 may also include a communication function such as Wi-Fi.

The vehicle-mounted gateway 122, which is a vehicle-mounted apparatus, has a role of connecting (through conversion of communication protocol and the like) a communication function used for external communication (in more detail, a given communication specification) to a communication function used for internal communication (which is also a communication specification). The autonomous driving ECU 126 can communicate with external apparatuses via this vehicle-mounted gateway 122 and the communication unit 120. As one example, the vehicle-mounted gateway 122 acquires dynamic information and the like out of information received from the outside via the communication unit 120 and generates and updates driving assistance information. This driving assistance information is transmitted to the autonomous driving ECU 126. The bus 132 handles a communication function for communication within the vehicle, with communication (that is, exchanging of data) between the vehicle-mounted gateway 122, the sensor 124, the autonomous driving ECU 126, and the ECU 128 being performed via this bus 132. As one example, CAN (Controller Area Network) is used for the bus 132.

The sensor 124 is mounted on the vehicle 102 and includes sensors for acquiring information outside the vehicle 102 (a video image capturing apparatus (as examples, a digital camera (such as a CCD (Charge-Coupled Device) camera or a CMOS (Complementary Metal-Oxide Semiconductor) camera), a laser sensor (LiDAR) or the like, and sensors for acquiring information about the vehicle itself (such as an acceleration sensor and a load sensor). The sensor 124 acquires information within its detection range (or image capture range in the case of a camera) and outputs such information as sensor data. When the sensor 124 is a digital camera, digital image data is output. The detection signal (which is analog or digital) of the sensor 124 is output as digital data via an interface unit (not illustrated) to the bus 132, and is transmitted to the vehicle-mounted gateway 122 and the autonomous driving ECU 126 or the like.

The autonomous driving ECU 126 controls the driving of the vehicle 102. As one example, the autonomous driving ECU 126 acquires the sensor data, analyzes such data to grasp the situation around the vehicle, and controls mechanisms related to autonomous driving (that is, mechanisms such as the engine, the transmission, the steering, and the brakes). The autonomous driving ECU 126 uses the driving assistance information acquired from the vehicle-mounted gateway 122 to perform autonomous driving.

The presentation unit 130 is an apparatus for presenting information, and is an image display device such as a liquid crystal display. The presentation unit 130 may include an audio device. The presentation unit 130 displays a road map or the like, and presents the driving assistance information, such as a driving route to the destination and route guidance information, superimposed on the road map.

### Hardware Configuration of Vehicle-Mounted Gateway

As depicted in FIG. 3, the vehicle mounted gateway 122 includes a control unit 140 and a memory 142. The control unit 140 includes a CPU (Central Processing Unit) and controls the memory 142. As one example, the memory 142 is a rewritable nonvolatile semiconductor memory, and stores a computer program (hereinafter simply referred to as the “program”) to be executed by the control unit 140. The memory 142 provides a workspace for the program executed by the control unit 140. The control unit 140 acquires data to be processed directly from the communication unit 120, and data from sources aside from the communication unit 120 via the bus 132. The control unit 140 stores data received from the communication unit 120 and data received via the bus 132 as appropriate in the memory 142. The control unit 140 stores processing results in the memory 142 and outputs such results to the bus 132.

### Hardware Configuration of Server

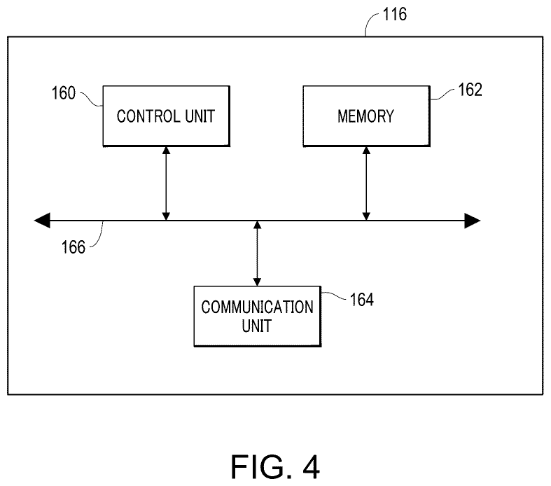

As depicted in FIG. 4, the server 116 includes a control unit 160 that controls the other components, a memory 162 that stores data, a communication unit 164 (communicator) that performs communication, and a bus 166 for exchanging data such components. The control unit 160 includes a CPU, and realizes the functions described below by controlling the respective components. The memory 162 includes a rewritable nonvolatile semiconductor memory and a large-capacity storage device, such as a hard disk drive. The communication unit 164 receives sensor data, which is uploaded from an infrastructure sensor 104 installed on a road or the like, via the base station 108. The data received by the communication unit 164 is transferred to and stored in the memory 162. By doing so, the server 116 generates traffic information (as examples, information on accidents, congestion, road restrictions, and statistical information), and dynamic information and the like, and transmit such information to the vehicle-mounted system 100 of the vehicle 102.

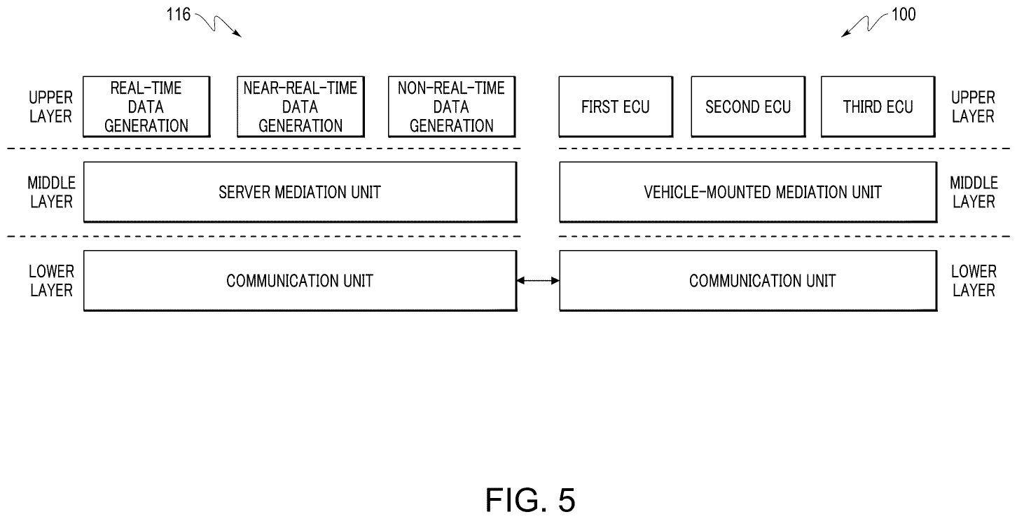

FIG. 5 depicts a software configuration for implementing the functions of the server 116 and the vehicle-mounted system 100.

### Software Configuration of Server

The software (that is, the program) of the server 116 is structured on three layers: an upper layer, a middle layer, and a lower layer. The upper layer indicates a plurality of applications (that is, programs) that generate data to be used in services in the vehicle (such as autonomous driving control and the provision of driving assistance information). Such applications are executed by the control unit 160 of the server 116, and data that is generated is classified according to the time taken from the occurrence of an event until the provision of such information. That is, three applications are executed, which respectively perform real-time data generation, near real-time data generation, and non-real-time data generation. The expressions “real time”, “near-real-time”, and “non-real-time” here refer for example to information that can be put to effective use for some type of service within several hundred milliseconds of an event, within several hundred milliseconds to 10 seconds of an event, and within 10 seconds to several tens of minutes of an event, respectively.

Real-time data generation is a process of generating dynamic information. As described earlier, dynamic information includes information about each dynamic object, that is, the position, movement direction, speed, attributes, and the like of a road user (a pedestrian, a vehicle, or the like) on the road. Near real-time data generation is a process of generating predictive information, for example. Such predictive information is a predicted value for t seconds from now for the road user identified by the dynamic information (that is, a prediction of the dynamic information in t seconds' time). Non real-time data generation is a process of generating statistical information, for example. The statistical information is information such as the number of road users and their movement speeds (such as their average speed). By transmitting such data to a vehicle, driving of the vehicle can be controlled safely and accurately. Note that the generated data may be data aside from the dynamic information, the predictive information, and the statistical information.

The middle layer is composed of a mediation unit (hereinafter referred to as the “server mediation unit”) that mediates between the upper layer (the applications) and the lower layer (which is a communication unit). The server mediation unit is executed by the control unit 160 of the server 116. The server mediation unit specifies applications at a destination vehicle (more specifically, a vehicle-mounted system) that are capable of appropriately using each piece of information that has been generated on the upper layer and regularly transmits (that is, broadcasts) the information to vehicles. Since a delay will occur due to transmission and processing at a vehicle, the data (that is, information) generated by an application on the upper layer may be configured so that the usage of the data at a vehicle will change in keeping with the data type of the data (that is, the data may be used by different applications).

The communication unit on the lower layer is composed of the communication unit 164 depicted in FIG. 4 and a device driver (software) for operating the communication unit 164. The server mediation unit operates the communication unit 164 using the device driver and communicates with the base station 108, the infrastructure sensor 104, and the vehicle-mounted system 100 (in more detail, the communication unit 120) of the vehicle 102 depicted in FIG. 1.

### Software Configuration of Vehicle-Mounted System

The software configuration of the vehicle-mounted system 100 is also composed of three layers, an upper layer, a middle layer, and a lower layer. On the upper layer, applications realized by a plurality of ECUs (hardware) are indicated as a “first ECU” to a “third ECU”. As examples, the first to third ECUs (applications) depicted in FIG. 5 are an application for controlling the sensor 124 depicted in FIG. 2, an application for the autonomous driving ECU 126, an application for motor control, or a combination thereof.

The applications on the upper layer are intended to realize services such as driving assistance, drive planning, and route selection. Driving assistance is a service that updates information about the vehicle's speed (including acceleration) and performs autonomous driving control using this information. Drive planning is a service that updates information about the lane in which the vehicle is running and performs autonomous driving control using this information. Route selection is a service that updates information relating to the driving route of the vehicle and performs autonomous driving control based on this information. As described earlier, these applications are executed through cooperation between the autonomous driving ECU 126 and the ECU 128 or the like. These applications enable safe and accurate control of the driving of the vehicle. Note that applications on the upper layer may realize services aside from driving assistance, drive planning, and route selection.

The middle layer is composed of a mediation unit (hereinafter referred to as the “vehicle-mounted mediation unit”) that mediates between the first to third ECUs (applications) on the higher layer and the lower layer (which is a communication unit). The vehicle-mounted mediation unit is executed by the vehicle-mounted gateway memory 142. As described later, the vehicle-mounted mediation unit performs processing to provide data received from the server 116 to the higher layer applications either as is or after appropriate conversion.

The communication unit on the lower layer is composed of the communication unit 120 depicted in FIG. 2 and a device driver for operating the communication unit 120. The vehicle-mounted mediation unit uses the device driver to operate the communication unit 120 and communicate with the server 116 (in more detail, the communication unit 164).

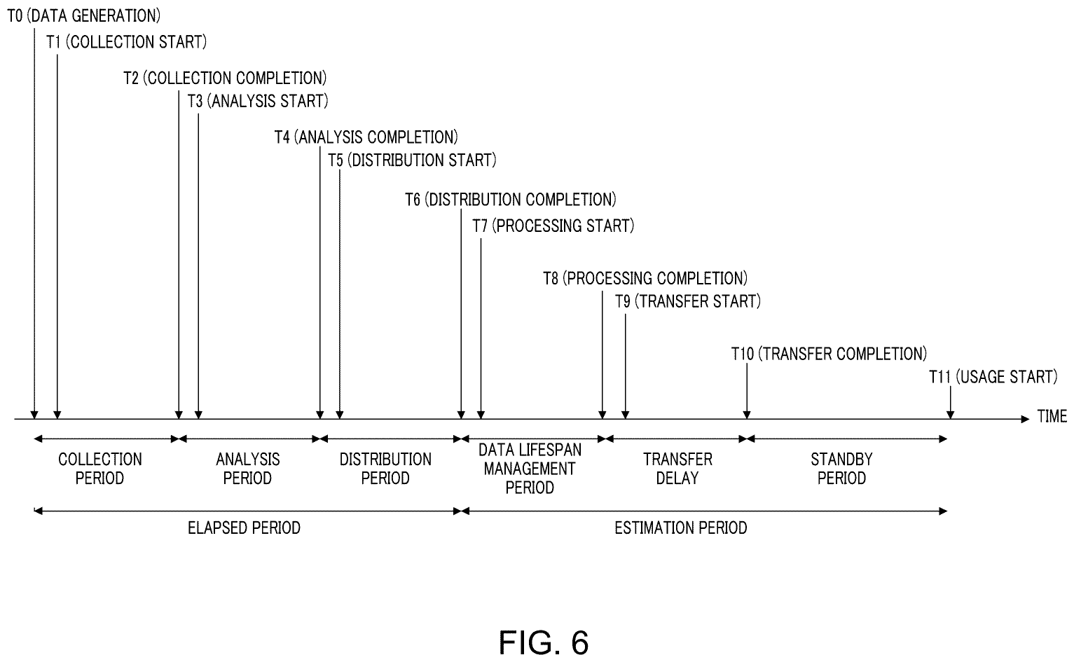

FIG. 6 is useful in explaining an overview of a series of processes, executed by the configuration depicted in FIG. 5, from collection of data (for example, sensor data) by the server 116 to the usage of such data in the vehicle mounted system 100. In FIG. 6, the horizontal axis represents time, with the downward arrows indicating the timing at which events occur. Note that FIG. 6 is intended to depict the order of events and the scale of the time axis is not constant, so that lengths along the time axis are not proportional to time.

At time T0, data is generated. That is, generation of sensor data (for example, video data) is commenced by the infrastructure sensor 104 or a vehicle-mounted sensor or the like. At time T1, the collection of sensor data commences. That is, sensor data (for example, video data) is transmitted from the infrastructure sensor 104 or a vehicle-mounted sensor or the like to the server 116, and the server 116 stores the received data in the memory 162. At time T2, the collection of data is completed. That is, transmission of the data generated at time T0 to the server 116 and storage in the memory 162 are completed. The period from time T0 to time T2 is called the “collection period”.

At time T3, the server 116 commences analysis of the received data, and at time T4 such analysis is completed. The analysis results are stored in the memory 162. The period from time T2 to time T4 is called the “analysis period”. At time T4, the server 116 reads out the analysis results from the memory 162, commences the distribution (as one example, broadcasting) of the analysis results to vehicles, and completes such distribution at time T6. The period from time T4 to time T6 is called the “distribution period”. During the distribution period, the vehicle-mounted system 100 for example receives the data being distributed.

The period from time T0 to time T6 is called the “elapsed period”. This elapsed period=collection period+analysis period+distribution period. The difference between time T0 and time T1, the difference between time T2 and time T3, and the difference between time T4 and time T5 indicate that there may be slight gaps between the completion of a preceding process and the execution of a following process. Such differences may be zero. In other words, the next process may start at the same time (which includes nearly simultaneously) with the completion of the preceding process.

After the distribution is completed at time T6, at time T7, the vehicle-mounted system 100 executes data lifespan management, which will be described later, for the received data. Data lifespan management is a process for determining whether the received data can be effectively used and, when the data cannot be effectively used, for executing an appropriate process as described later. At time T8, the data lifespan management is completed. The period from time T6 to time T8 is called the “data lifespan management period”. After this, at time T9, a process that transfers the received data to the ECU where the data will be used (hereinafter referred to as the “end ECU”) commences. Next, at time T10, such transferring is completed. The period from time T8 to time T10 is called the “transfer delay”.

Even when the transferring of data has completed at time T10, some time will normally be taken for such data to be used by the end ECU. As one example, when the end ECU uses the transferred data for driving control, the end ECU will use the transferred data in a state where the vehicle 102 has approached the location where the data that was the basis for the transferred data (that is, the data received from the server 116) was generated. Accordingly, during the time taken for the vehicle 102 to reach the vicinity of the generation location of the data, the end ECU holds the transferred data (as one example, the data is stored in a memory) without using the data and thereby delays the usage of the data. At time T11, the end ECU commences the usage of the transferred data. The period from time T10 to time T11 is called the “standby period”.

The time from time T6 to time T11 is called the “estimation period”. The estimation period=data lifespan management period+transfer delay+standby period. The difference between times T6 and T7 and the difference between times T8 and T9 indicate that as described above, there may be a slight interval between the completion of a preceding process and the execution of a following process. Such differences may be zero.

### Server Operation

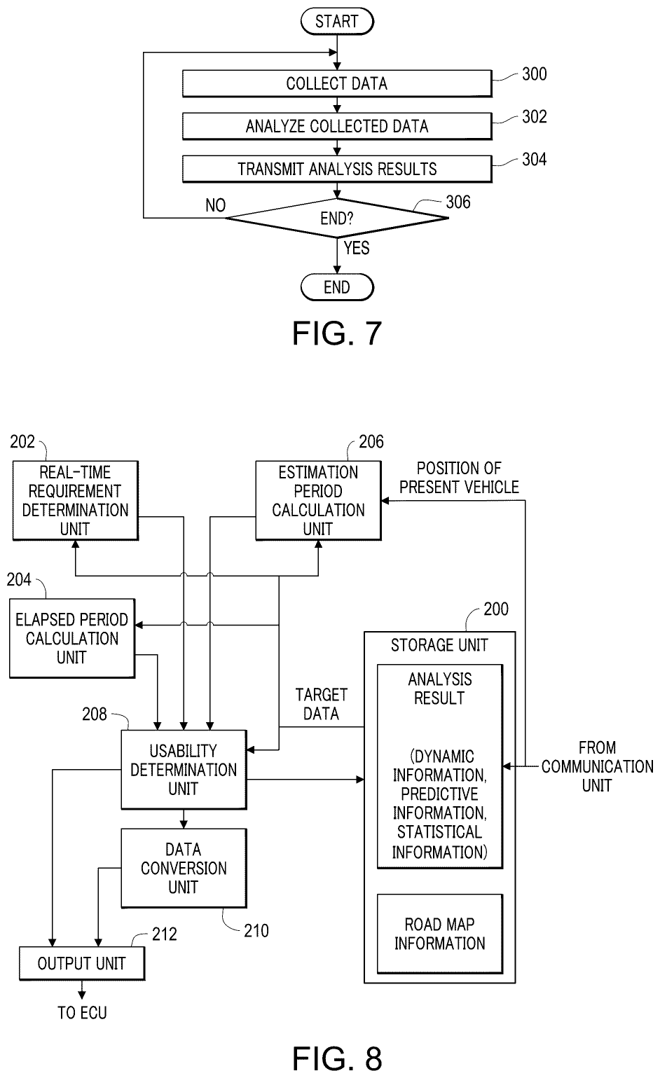

The operation of the server 116, that is, data collection, analysis, and distribution to vehicles, will now be described with reference to FIG. 7. The process depicted in FIG. 7 is realized by the control unit 160 of the server 116 depicted in FIG. 4 reading a predetermined program from the memory 162 and executing the program. The process depicted in FIG. 7 corresponds to the software in the upper and middle layers depicted in FIG. 5, with a plurality of programs being executed in parallel. That is, the control unit 160 reads a plurality of programs from the memory 162 and executes such programs by multitasking.

In step 300, the control unit 160 collects data (sensor data and the like) transmitted from the infrastructure sensor 104, the vehicle 102, the other vehicle 112, or the like. After this, the control proceeds to step 302. In more detail, the control unit 160 receives data via the communication unit 164 and stores the received data in the memory 162. When doing so, the control unit 160 adds time information to the received data (for example, sensor data) before storing the data. If information on the generation time of the sensor data (that is, a time detected by the sensor) has been appended to the received sensor data, the control unit 160 adds such generation time as the time information. If a generation time has not been appended to the sensor data, the control unit 160 adds the time of reception of the data by the communication unit 164 as the time information.

In step 302, the control unit 160 reads out the data collected in step 300 from the memory 162, analyzes the data, and stores the analysis results in the memory 162. The analysis is executed in parallel by each application on the upper layer depicted in FIG. 5. Accordingly, the same data may be subjected to analysis by different applications. After this, the control proceeds to step 304.

In step 304, the control unit 160 reads the analysis results produced by step 302 from the memory 162, adds information specifying an application of the vehicle to which the analysis results are to be transmitted, and transmits (as one example, broadcasts) the results as driving assistance information. After this, the control proceeds to step 306. As one example, the analysis results are dynamic information, predictive information, and statistical information. As described earlier, the applications (that is, the services) that can appropriately use the analysis results at the vehicle to which analysis results are transmitted will vary depending on the type of the analysis results. Accordingly, the control unit 160 specifies the applications at the vehicle to which the information will be passed in keeping with the type of the analysis results read from the memory 162, and transmits the analysis results after appending such specifying information (that is, “service specifying information”). As examples, applications at a vehicle implement services such as driving assistance, drive planning, and route selection. When transmitting to a specific vehicle, the address (the MAC address or IP address) of the destination ECU and the destination port number can be used as the service specifying information. When transmission is performed by broadcasting, as one example a destination port number can be used as the service specifying information. Note that a unique ID that has been agreed upon in advance by the server 116 and the vehicle-mounted system 100 may also be used.

In step 306, the control unit 160 determines whether an end instruction has been received. As one example, an end instruction is made by operating an operation unit (not illustrated) such as a keyboard or mouse provided at the server 116. When it is determined that the processing is to end, the program ends. If not, the control returns to step 300 and the processing described above is repeated.

### Functional Configuration of Vehicle-Mounted Gateway

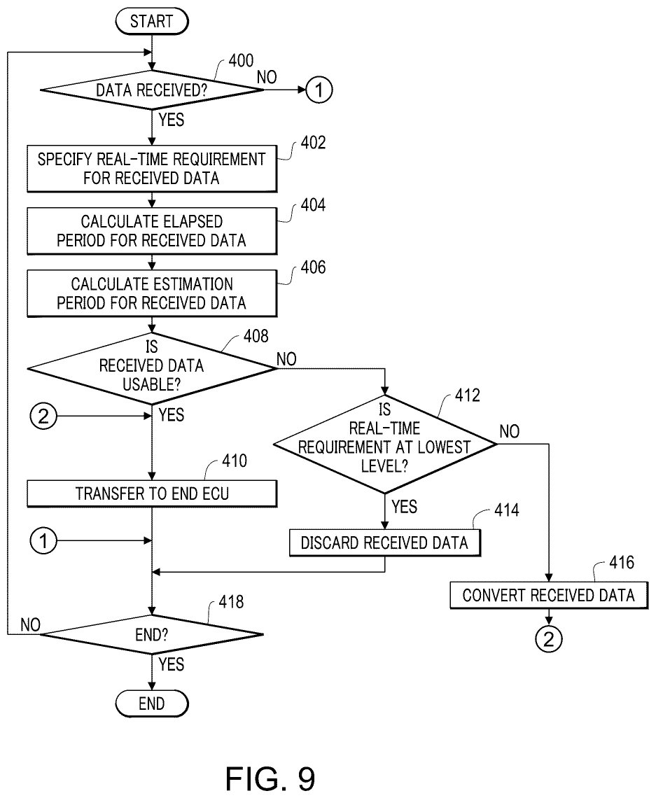

The functions of the vehicle mounted gateway 122 will now be described with reference to FIG. 8. The vehicle-mounted system 100 acquires driving assistance information, such as dynamic information, from the server 116.

The vehicle-mounted gateway 122 includes a storage unit 200, a real-time requirement determination unit 202, an elapsed period calculation unit 204, an estimation period calculation unit 206, a usability determination unit 208, a data conversion unit 210, and an output unit 212. The storage unit 200 is realized by the memory 142 in FIG. 3. The other functions, which will be described later, are realized by the control unit 140. In terms of correspondence with the configuration depicted in FIG. 5, the real-time requirement determination unit 202, the elapsed period calculation unit 204, the estimation period calculation unit 206, the usability determination unit 208, and the data conversion unit 210 are functions of the vehicle-mounted mediation unit on the middle layer. The storage unit 200 stores analysis results (for example, dynamic information, predictive information, and statistical information) and road map information. As one example, the road map information is static information that is stored in advance. The analysis results are data received from the server 116 by the communication unit 120. Note that the analysis results are stored without being classified. The real-time requirement determination unit 202, the elapsed period calculation unit 204, the estimation period calculation unit 206, and the usability determination unit 208 read out the same data (that is, the analysis results) from the storage unit 200 and process the data.

The real-time requirement determination unit 202 reads data (in more detail, any one of dynamic information, the predictive information, and the statistical information) stored in the storage unit 200 and specifies the real-time requirement of the data. The storage unit 200 outputs the specified real-time requirement to the usability determination unit 208. The real-time requirement of data represents the tolerated delay time (hereinafter, the “tolerated delay”) from when data (that is, sensor data or the like) that formed the basis for such data was generated (or acquired) until the appropriate usage of data at a vehicle. The real-time requirement is determined as depicted in Table 1, for example.

TABLE 1

| | |
|---|---|
| Real time requirement | Tolerated delay td |

| | | |
|---|---|---|
| A | Real time | td ≤ several hundred ms |
| B | Near-real time | several hundred ms < td ≤ 10 s |
| C | Non-real time | 10 s < td ≤ several tens of min |

The real-time requirement may be agreed upon in advance by the server 116 and the vehicle-mounted system 100. Since the server 116 can transmit driving assistance information (analysis results) appended with a predetermined ID indicated the real-time requirement, it is possible for the real-time requirement determination unit 202 to identify the real-time requirement from this ID. By doing so, the real-time requirement can be determined with high accuracy. As one example, the real-time requirements from A to C can be specified in keeping with the type of data as depicted in Table 2.

TABLE 2

| Data type | Real time requirement |
|---|---|
| Dynamic information | A |
| Predictive information | B |
| Statistical information | C |

The real time requirement determination unit 202 may also determine the real-time requirement from the service (hereinafter “applied service”) to which the data received from the server 116 is to be applied (that is, the application to which the received data is passed). The applied service of the received data can be specified by a destination port number. By doing so, it is easy to determine the real-time requirement. The real-time requirement determination unit 202 (that is, the vehicle-mounted mediation unit) may also observe an update period of the applied service (that is, the operation period or the like of the processing units (including software and hardware) in the vehicle-mounted system 100 and the server 116 relating to this applied service) to determine the real-time requirement. As one example, as depicted in Table 3, the real-time requirements A to C are specified according to the applied service.

TABLE 3

| Applied service | Real time requirement |
|---|---|
| Driving assistance | A |
| Drive planning | B |
| Route selection | C |

Note that if an applied service performs processing on a plurality of types of data, it will not be possible to simply specify the real-time requirement even if the applied service itself can be specified. In such cases, the real-time requirement determination unit 202 may analyze the data received from the server 116 (that is, analyze the data format and data structure, for example), specify the type of data, and specify the real-time requirement from the type of data.

The real-time requirement determination unit 202 may also specify the real-time requirement according to the type of data specified as described above and the applied service. As one example, the real-time requirements A to C are determined according to combinations of data types and applied services as depicted in Table 4.

TABLE 4

Applied service

| | Driving | Drive | Route |
|---|---|---|---|
| Data type | assistance | planning | selection |
| Dynamic information | A | A | A |
| Predictive information | A | B | B |
| Statistical information | A | B | C |

The elapsed period calculation unit 204 calculates an elapsed period relating to the analysis result data (in more detail, the dynamic information, the predictive information, and the statistical information) stored in the storage unit 200. The storage unit 200 outputs the calculated elapsed period to the usability determination unit 208. As described earlier, the elapsed period is the time from the generation of the data (time T0 indicated in FIG. 6) to the completion of distribution of the analysis result data by the server 116 (time T6 indicated in FIG. 6). As one example, when analysis result data is transmitted from the server 116, if time T0 has been added to the analysis result data before distribution, the vehicle mounted system 100 can calculate the elapsed period as the difference between the reception time of the data and the time T0 that was appended to the received data. Note that the information indicating time T0 can be added to the sensor data before transmission to the server 116 by the apparatus that is the transmission source of the sensor data, such as the infrastructure sensor 104.

The estimation period calculation unit 206 calculates an estimation period relating to the analysis result data (in more detail, the dynamic information, the prediction information, and the statistical information) stored in the storage unit 200. The storage unit 200 outputs the calculated estimation period to the usability determination unit 208. As described earlier, the estimation period is the time from when the vehicle-mounted system 100 completes reception of the analysis result data from the server 116 (time T6 indicated in FIG. 6) to when usage is commenced (time T11 indicated in FIG. 6). Although the estimation period will be determined once time T11 is reached, the estimation period will be yet to be determined immediately after the vehicle mounted system 100 has received the data from the server 116 (time T6 indicated in FIG. 6). Accordingly, the vehicle-mounted system 100 (the vehicle-mounted gateway 122) calculates, that is, estimates the estimation period during the data lifespan management period.

The estimation period includes the data lifespan management period, the transfer delay, and the standby period. Out of these, the transfer delay is the time required to read the data to be transferred from the storage unit 200 and transfer the data via the bus 132 to the end ECU, and can be calculated from the size of the data to be transferred and the current state of the bus 132 (that is, the free capacity and the transfer speed). The standby period is the time required for the vehicle 102 to travel from its current position to the location (which is included in the analysis result data) where the analysis result data is to be used. The location where the analysis result data is to be used can be determined, for example, from position information of a dynamic object included in the dynamic information. Accordingly, the distance from the current position of the vehicle 102 to the location where the analysis result data is to be used can be calculated, and the standby period can be calculated by dividing the calculated distance by the speed of the vehicle 102 (as examples, the current speed or the average speed over a predetermined period in the past).

The data lifespan management period includes the time required for the vehicle-mounted gateway 122 to calculate the transfer delay and the standby period and, as described later, the time required for the vehicle mounted gateway 122 to perform a process of determining whether the vehicle-mounted system 100 can effectively use the received data (this refers to the function of the usability determination unit 208). Such periods can be predicted in advance from the processing performance of the vehicle-mounted gateway 122, the number of processing steps, the processing time of each step, and the like. Accordingly, a predetermined value (that is, a predetermined time) is used for the data lifespan management period. In other words, the estimation period is calculated as estimation period=transfer delay+standby period+predetermined time. In addition, a statistical value calculated from a group of processing times obtained by executing the processing in question a plurality of times (as one example, actual measured values for processing performed in the past) may be used for the data lifespan management period. As examples of this statistical value, an average value, a median value, or a value determined from a cumulative distribution function (CDF) can be used. Note that a statistical value may also be used for the transfer delay.

The usability determination unit 208 determines whether the data received from the server 116 (that is, the analysis result) can be effectively used. In other words, the usability determination unit 208 uses the real-time requirement (specifically, the tolerated delay td) input from the real-time requirement determination unit 202, the elapsed period tp input from the infrastructure sensor 104, and the estimation period tf input from the estimation period calculation unit 206 to determine whether tp+tf<td. That is, it is determined whether it is possible to commence use of the received data before the tolerated delay, during which the data can be used effectively, elapses. If it has been determined that tp+tf<td, the usability determination unit 208 outputs the target data to the output unit 212 together with information specifying the end ECU that is the transmission destination. The output unit 212 transfers the input data to the target ECU (or “end ECU”). If tp+tf<td does not hold (that is, tp+tf≥td), the usability determination unit 208 outputs the target data and the real-time requirement to the data conversion unit 210.

The data conversion unit 210 lowers the input real-time requirement by one level, converts the input data to match this lowered real-time requirement, and outputs the converted data together with information for specifying the end ECU that is the transmission destination to the output unit 212. As one example, if the information is dynamic information (whose real-time requirement=A), predictive information (whose real-time requirement=B) is generated. If the information is predictive information (whose real-time requirement=B), the data conversion unit 210 generates statistical information (whose real-time requirement=C). When doing so, the data conversion unit 210 may appropriately change the end ECU to which the converted data is to be transmitted in keeping with the lowered real-time requirement. The output unit 212 transfers the input data to a destination ECU (or “end ECU”). If the input real-time requirement is already at the lowest level and cannot be lowered further, the data conversion unit 210 discards the data in question.

By doing so, the vehicle-mounted system 100 can make effective use of data (that is, analysis results) received from the server 116 for driving control (for example, autonomous driving control) of the vehicle in which it is provided (that is, the vehicle 102), for presenting driving assistance information (for example, route guidance), and the like.

Even if the received data cannot be used as is, the vehicle-mounted system 100 will convert such data into usable data which is then used. Accordingly, it is possible to suppress the wasteful transmission of data from the server 116 and the reception of data by the vehicle mounted system 100. In addition, since data that cannot be used effectively is discarded, it is possible to suppress the wasteful storage of unused data.

As described above, the received data is used by an ECU installed in the vehicle 102. The estimation period calculation unit 206 (see FIG. 8) can calculate the estimation period by adding the transfer delay, which is the time required to transfer the received data to the ECU, the standby period, which is the time from completion of transfer of the received data until the vehicle reaches a position where the received data is to be used, and the predetermined time. The predetermined time represents the total of the processing time of the real-time requirement determination unit 202, the processing time of the elapsed time calculation unit 204, and the processing time of the usability determination unit 208. By doing so, the vehicle mounted gateway 122 is capable of making much more effective use of the received data (which for example is driving assistance information).

### Operation of Vehicle-Mounted Gateway

The operation of the vehicle-mounted gateway 122 will now be described with reference to FIG. 9, while referring to the functions depicted in FIG. 8. The processing depicted in FIG. 9 is realized by the control unit 140 (see FIG. 3) reading a predetermined program from the memory 142 and executing the program.

As depicted in FIG. 9, in step 400, the control unit 140 determines whether data (that is, driving assistance information) has been received from the server 116. If it is determined that data has been received, the control proceeds to step 402.

If not, the Control Proceeds to Step 418.

In step 402, the control unit 140 determines the real-time requirement for the data received in step 400. That is, the control unit 140 determines the real-time requirement based on at least one of the applied service of the data and the type of data, as described above with respect to the real-time requirement determination unit 202 depicted in FIG. 8. After this, the control proceeds to step 404.

In step 404, the control unit 140 calculates the elapsed time for the received data. That is, the control unit 140 calculates the time from the generation of the original data to the reception of the data generated from the original data as described above with respect to the elapsed period calculation unit 204 depicted in FIG. 8, and sets the calculated time as the elapsed period. After this, the control proceeds to step 406.

In step 406, the control unit 140 calculates the estimation period for the received data. That is, the control unit 140 calculates the time from when the data is received until the start of usage, as described above with respect to the estimation period calculation unit 206 depicted in FIG. 8, and sets the calculated time as the estimation period. After this, the control proceeds to step 408.

In step 408, the control unit 140 determines whether the data received by step 400 can be effectively used in the vehicle in which the control unit 140 is installed. That is, as described above with respect to the usability determination unit 208 depicted in FIG. 8, the control unit 140 determines whether tp+tf<td using the real-time requirement (in more detail, the tolerated delay td), the elapsed period tp, and the estimation period tf determined in steps 402 to 406. If it has been determined that tp+tf<td, the control proceeds to step 410. If not, the control proceeds to step 412.

In step 410, the control unit 140 transfers the data to be transferred to the end ECU to execute the applied service of the data. The data to be transferred referred to here is the data that was received in step 400 or is data produced by conversion in step 416, which will be described later. After this, the control proceeds to step 418.

If the result of the determination in step 408 is NO (that is, tp+tf≥td), in step 412, the control unit 140 determines whether the real-time requirement specified by step 402 is the lowest level. As one example, when the real-time requirement is defined as depicted in Table 1, it is determined whether the real-time requirement is C. If the real-time requirement has determined to be at the lowest level, the control proceeds to step 414. If not, the control proceeds to step 416.

In step 414, the control unit 140 discards the data received in step 400. That is, since the received data cannot be used effectively, the control unit 140 discards the data without storing it in the memory 142. After this, the control proceeds to step 418.

In step 416, the control unit 140 converts the data received by step 406. That is, as described above with respect to the data conversion unit 210 depicted in FIG. 8, the control unit 140 lowers the real-time requirement of the received data by one level and converts the received data to match this lowered real-time requirement. After this, the control proceeds to step 410.

In step 418, the control unit 140 determines whether an end instruction has been received. As one example, this end instruction is made by turning off a start button or the like of the vehicle 102. If it has been determined that the processing is to end, the program ends. If not, the control returns to step 400 and the processing described above is repeated.

As a result, the vehicle-mounted system 100 can effectively use the data received from the server 116 for driving control of the present vehicle (that is, autonomous driving control) and for presenting driving assistance information (for example, route guidance). Even if the received data cannot be used as is, the vehicle-mounted system 100 will convert the data into usable data and then use the converted data. Accordingly, it is possible to prevent transmission of data from the server 116 and reception of data by the vehicle mounted system 100 from going to waste.

Although a case where the control proceeds to step 410 after step 416 has been described above, the present disclosure is not limited to this. After step 416, the control may proceed to step 408 instead of step 410. That is, a determination may be made of whether the data resulting from the change to the real-time requirement can be effectively used in the present vehicle. As one example, if the tolerated delay is not satisfied even when the real-time requirement has been lowered by one level from A to B and data conversion has been performed, it will be necessary to further lower the level of the real-time requirement from B to C and to further convert the data.

### Modifications

Although a configuration where the vehicle-mounted system 100 mounted in the vehicle 102 determines whether the driving assistance information received from the server 116 can be effectively used has been described above, the present disclosure is not limited to this. In this modification, before transmitting the driving assistance information, the server identifies a vehicle at which the driving assistance information can be effectively used.

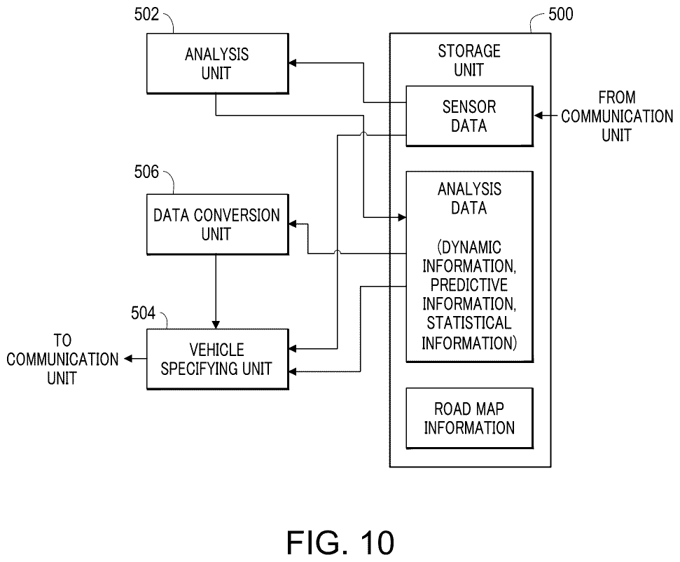

The server according to this modification has the same configuration as the server 116 depicted in FIG. 4. The following description makes reference to the reference numerals indicated in FIG. 4, with the server 116 as the server in the present modification. The functions of the server 116 will now be described with reference to FIG. 10. A storage unit 500 depicted in FIG. 10 is realized by the memory 162 in FIG. 4. Other functions, which will be described later, are realized by the control unit 160.

The storage unit 500 stores sensor data received via a communication unit from the infrastructure sensor 104 or the like. As one example, the road map information is static information that is stored in advance. The storage unit 500 also stores analysis results produced by an analysis unit 502, which is described below.

The analysis unit 502 reads out the sensor data stored in the storage unit 500, performs analysis, and stores the results (that is, the “analysis results”) in the storage unit 500. As examples of the analysis results, dynamic information, predictive information, and statistical information are stored.

A vehicle specifying unit 504 specifies the vehicle(s) to which the analysis results will be transmitted, outputs the analysis results to the communication unit 164, and transmits the analysis results to the specified vehicle(s). The vehicle specifying unit 504 specifies vehicles located within a predetermined region (such as a rectangle or circle) that is centered on a generation location where the sensor data on which the analysis results are based was generated as the vehicles to which the analysis results will be transmitted. That is, the vehicle specifying unit 504 transmits the analysis results to vehicles that satisfy the real-time requirement of the analysis results, that is, vehicles that may reach the generation location of the sensor data within the tolerated delay. As one example, by referring to a road map stored in the storage unit 500, the predetermined region can be determined by multiplying the speed of vehicles in the periphery of the generation location of the sensor data by the tolerated delay (as one example, an upper limit) of the analysis results and using the obtained value (that is, a distance) as the distance from the generation location of the sensor data to the outer edge of the predetermined region. As examples, the speed of a vehicle may be the legal speed limit or an average of observed vehicle speeds. The distance from the generation location of the sensor data to the outer edge of the predetermined region may be a straight line distance or a distance along a road. Note that in order to specify vehicle-mounted apparatuses of vehicles that are present within the predetermined region, it is possible for example to broadcast an instruction for such vehicle-mounted apparatuses to transmit the location information of the respective vehicles. The vehicles to which the analysis results are to be transmitted may be specified using this location information sent in reply from the vehicles.

Note that in order to specify the generation location of the sensor data, position coordinates where the sensor data was detected may be appended to the sensor data transmitted by an infrastructure sensor 104 or the like and the resulting data may be transmitted to the server 116. In addition, for a sensor, such as the infrastructure sensor 104, installed at a fixed location, if the location of the sensor is registered in advance in the storage unit 500, information identifying the transmission source may be added to the sensor data before transmission of the sensor data. As one example, if the storage unit 500 stores a table in which MAC addresses are associated with position coordinates, it will be possible to specify the transmission source from the MAC address included in transmission packets including the sensor data, so that the generation location of the sensor data can be specified.

A data conversion unit 506 lowers the real-time requirement of the analysis results (which for example is dynamic information) and then converts the data into data corresponding to the lowered real-time requirement. As one example, when dynamic information (whose real-time requirement=A) is generated as the analysis results and the data conversion unit 506 lowers the real-time requirement by one level, predictive information (whose real-time requirement=B) is generated from the dynamic information. For predictive information (whose real-time requirement=B), statistical information (whose real-time requirement=C) is generated from the predictive information. The data generated with the lowered real-time requirement is input into the vehicle specifying unit 504. The vehicle specifying unit 504 uses the tolerated delay corresponding to the input data (that is, data generated with a lowered real-time requirement) in the same way as described above to specify the vehicles to which data is to be transmitted, and outputs the data to the communication unit. In other words, the data generated with the lowered real-time requirement is transmitted to the vehicle-mounted apparatuses of vehicles positioned within a newly specified predetermined region.

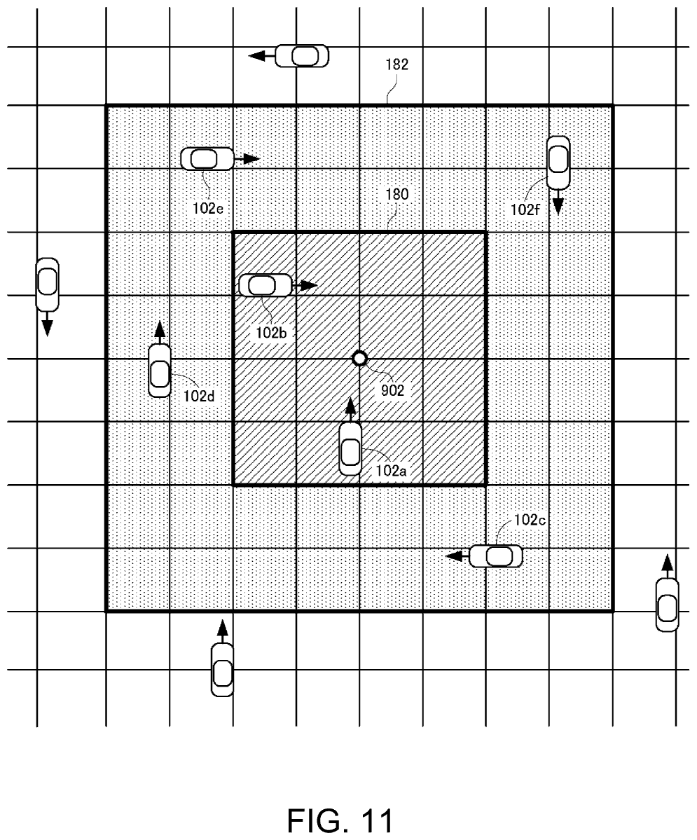

As one example, as depicted in FIG. 11, the range in which the analysis results are transmitted can be determined according to the type of data in the analysis results. In FIG. 11, the driving direction of each vehicle is indicated by an arrow. The server 116 transmits dynamic information (whose real-time requirement=A) to the vehicles 102a and 102b positioned in a region defined by a boundary 180 indicated by a thick solid line, with a data generation location 902 at the center. The server 116 transmits the predictive information (whose real-time requirement=B) to the vehicles 102c to 102f located in the region defined by the boundary 180 and a boundary 182 indicated by a thick solid line. The server 116 transmits statistical information (whose real-time requirement=C) to vehicles located in other regions. Note that the predictive information and the statistical information may be transmitted to the vehicles 102a and 102b in addition to the dynamic information. The statistical information may be transmitted to the vehicles 102c to 102f in addition to the predictive information.

By doing so, it is possible for the server 116 to transmit the driving assistance information only to vehicles that can effectively use such information, which suppresses wasteful transmission to vehicles that cannot effectively use the driving assistance information. At each vehicle, the received data can be quickly transferred to the applied service (that is, the end ECU) without having to determine whether the received driving assistance information can be effectively used. Accordingly, the load of the vehicle-mounted gateway 122 in the vehicle-mounted system 100 is reduced.

The server 116 reduces the real-time requirement of the analysis results (which for example is dynamic information), converts the data to data corresponding to the lowered real-time requirement, and transmits the resulting data to vehicles, thereby enabling a larger number of vehicles to effectively use the driving assistance information.

Note that each process (that is, each function) in the embodiments described above may be realized by a processing circuit (or “circuitry”) including one or a plurality of processors. Such processing circuit may be configured by an integrated circuit or the like in which one or a plurality of memories, various analog circuits, and various digital circuits are combined together with the one or a plurality of processors. The one or a plurality of memories store programs (instructions) that cause the one or a plurality of processors to execute the processes described above. The one or a plurality of processors may execute each of the above processes according to a program read from the one or a plurality of memories, or may execute each of the above processes according to a logic circuit designed in advance to execute each of the above processes. The processors may be a variety of processors that are suited to control by a computer, such as a CPU, a GPU (Graphics Processing Unit), a DSP (Digital Signal Processor), an FPGA (Field Programmable Gate Array), and an ASIC (Application Specific Integrated Circuit). Note that a plurality of processors that are physically separated may cooperate with each other to execute the above processes. As one example, processors respectively installed in a plurality of physically separated computers may cooperate with each other via a network, such as a LAN (Local Area Network), a WAN (Wide Area Network), or the Internet, to execute the processes described above.

Although the present disclosure has been described above by way of various embodiments, all features of the embodiments disclosed here are exemplary and should not be regarded as limitations on the present disclosure. The scope of the present disclosure is indicated by the individual claims provided in the patent claims which are to be interpreted with consideration to the detailed description of the disclosure, and is intended to include all changes within the meaning and scope of the wording of the claims and its equivalents.

1. A vehicle-mounted apparatus configured to be mounted in a vehicle, the vehicle-mounted apparatus comprising:
a processor configured to:
determine a real-time requirement relating to received data that has been received from outside the vehicle;
calculate an elapsed period that is a time from generation of original data for the received data until the received data is received by the vehicle-mounted apparatus;
calculate an estimation period from reception of the received data until usage of the received data commences; and
determine whether the received data is usable based on the real-time requirement, the elapsed period, and the estimation period, wherein:
the real-time requirement indicates a tolerated delay from generation of the original data to the usage of the received data,
the received data has been appended with time information for specifying a time when the original data was generated, and
the processor calculates the elapsed period based on a reception time of the received data and the time information.

2. The vehicle-mounted apparatus according to claim 1, wherein the processor is configured to:
determine that the received data is unusable if a total of the elapsed period and the estimation period does not satisfy the real-time requirement; and
convert, based on a determination that the received data is unusable, the received data into low-requirement data with a lower real-time requirement than the real-time requirement of the received data,
wherein when the processor is not capable of generating the low-requirement data, the received data is discarded.

3. The vehicle-mounted apparatus according to claim 1, wherein:
the received data is appended with service specifying information for specifying a service where the received data is to be used, and
the processor determines the real-time requirement based on the service specifying information.

4. The vehicle-mounted apparatus according to claim 1,
wherein the processor determines the real-time requirement based on at least one of a type of the received data and a service where the received data is to be used.

5. The vehicle-mounted apparatus according to claim 4, wherein:
the type includes dynamic information, predictive information, and statistical information, and
the service includes driving assistance including control of a driving speed of the vehicle, drive planning including control of a lane in which the vehicle is running, and route selection for controlling the planned driving route of the vehicle.

6. The vehicle-mounted apparatus according to claim 1, wherein:
the received data is used by an electronic control unit mounted in the vehicle,
the processor calculates the estimation period by adding a transfer delay, which is a time required to transfer the received data to the electronic control unit, a standby period, which is a time required for the vehicle to reach a position where the received data is to be used, and a predetermined time, and
the predetermined time represents a total of a processing time of the processor.

7. A vehicle-mounted system configured to be mounted in a vehicle, the vehicle-mounted system comprising:
the vehicle-mounted apparatus according to claim 1;
a communicator configured to receive the received data; and
an electronic control unit to which the received data that has been determined by the vehicle-mounted apparatus to be usable is transferred.

8. A server computer comprising:
a communicator configured to receive sensor data from outside; and
a processor configured to:
analyze the sensor data and generate first driving assistance information; and
specify a first vehicle capable of reaching a generation location of the sensor data within a first tolerated delay corresponding to a first real-time requirement corresponding to the first driving assistance information,
wherein the communicator also transmits the first driving assistance information to a vehicle-mounted apparatus of the first vehicle.

9. The server computer according to claim 8, wherein:
the processor is configured to generate, from the first driving assistance information, second driving assistance information corresponding to a second real-time requirement obtained by lowering the first real-time requirement,
the processor is configured to specify a second vehicle capable of reaching the generation location within a second tolerated delay corresponding to the second real-time requirement, and
the communicator also transmits the second driving assistance information to a vehicle-mounted apparatus of the second vehicle.

10. A control method of a vehicle-mounted system including a vehicle-mounted apparatus mounted in a vehicle, the control method comprising:
determining a real-time requirement relating to received data that has been received from outside the vehicle;
calculating an elapsed period that is a time from generation of original data for the received data until the received data is received by the vehicle-mounted apparatus;
calculating an estimation period from reception of the received data until usage of the received data commences; and
determining whether the received data is usable based on the real-time requirement, the elapsed period, and the estimation period, wherein:
the real-time requirement indicates a tolerated delay from generation of the original data to the usage of the received data,
the received data has been appended with time information for specifying a time when the original data was generated, and
calculating the elapsed period includes calculating the elapsed period based on a reception time of the received data and the time information.

11. A storage medium that stores a computer program that causes a processor mounted in a vehicle to implement:
determining a real-time requirement relating to received data that has been received from outside the vehicle;
calculating an elapsed period that is a time from generation of original data for the received data until reception of the received data;
calculating an estimation period from reception of the received data until usage of the received data commences; and
determining whether the received data is usable based on the real-time requirement, the elapsed period, and the estimation period, wherein:
the real-time requirement indicates a tolerated delay from generation of the original data to the usage of the received data,
the received data has been appended with time information for specifying a time when the original data was generated, and
calculating the elapsed period includes calculating the elapsed period based on a reception time of the received data and the time information.
